(19) United States
(12) Patent Application Publication
(10) Pub. No.: US 2024/0319904 A1
(43) Pub. Date: Sep. 26, 2024

(54) AUTONOMOUS COPY BETWEEN EXTERNAL MEMORY AND INTERNAL MEMORY

(71) Applicant: MediaTek Inc., Hsin-Chu (TW)

(72) Inventors: Pao-Hung Kuo, Hsinchu City (TW); Po-Chun Fan, Hsinchu City (TW); Sheng-Yen Yang, Hsinchu City (TW)

(73) Assignee: MediaTek Inc., Hsin-Chu (TW)

(21) Appl. No.: 18/407,990

(22) Filed: Jan. 9, 2024

Related U.S. Application Data
(60) Provisional application No. 63/491,965, filed on Mar. 24, 2023.

(51) Int. Cl. G06F 3/06

(52) U.S. Cl. CPC G06F 3/065; G06F 3/0604; G06F 3/0659; G06F 3/0683

(57) ABSTRACT

A method of managing access to a first memory via a second memory includes autonomously copying data from one or more of the data blocks in the first plurality of data blocks in the first memory to corresponding one or more of the data blocks in the second plurality of data blocks in the second memory sequentially. Access to the first memory with a first plurality of data blocks is at a first speed and access to the second memory with a second plurality of data blocks is at a second speed. A command is received for reading from the second memory. Responsive to receiving the command, a pointer is obtained indicating an address of a data block in the second memory that contains data copied from the first memory and that is first available for access. The data is obtained from the data block based on the pointer.

### CROSS-REFERENCE TO RELATED APPLICATIONS

This application claims benefit of priority under 35 U.S.C. § 119(e) to U.S. Provisional Application No. 63/491,965, filed Mar. 24, 2023, and entitled “RING BUFFER AUTO-COPY MECHANISM WITH PROGRAMMING APIS,” the entirety of which is hereby incorporated herein by reference.

### BACKGROUND

Aspects of the technology relate to memory access in an application programming interface (API) and, more particularly, to autonomous copy between external memory and internal memory.

Any software that performs a function may be regarded as an application. When applications interact with each other, an API simplifies the integration between the applications and facilitates seamless communication. APIs provide security by isolating the infrastructure of each of the applications being interfaced via the API. Data transfer between the two applications is a core function of an API. Thus, latency (i.e., time delay) between a request for information by one of the applications and delivery of that information is a consideration in the design of APIs.

### SUMMARY

According to one or more embodiments, a method of managing access to a first memory is via a second memory. Access to the first memory is at a first speed and the first memory includes a first plurality of data blocks. Access to the second memory is at a second speed, different from the first speed, and the second memory includes a second plurality of data blocks. The method includes autonomously copying data from one or more of the data blocks in the first plurality of data blocks in the first memory to corresponding one or more of the data blocks in the second plurality of data blocks in the second memory sequentially. The method also includes receiving a command for reading from the second memory. Responsive to receiving the command for reading from the second memory, the method includes obtaining a pointer indicating an address of a data block in the second memory that contains data copied from the first memory and that is first available for access, and obtaining the data from the data block based on the pointer.

According to another embodiment, a system includes an internal memory, and one or more processors to access an external memory via the internal memory. Access to the first memory is at a first speed and the first memory includes a first plurality of data blocks. Access to the second memory is at a second speed, different from the first speed, and the second memory includes a second plurality of data blocks. The one or more processors autonomously copy one or more of the data blocks in the plurality of data blocks in the external memory to corresponding data blocks in the internal memory. The one or more processors also receive a command for reading from the internal memory. Responsive to receiving the command for reading from the internal memory, the one or more processors obtain a pointer indicating an address of a data block in the internal memory that contains data copied from the external memory and is available for access and obtaining the data from the data block based on the pointer.

The foregoing has outline some of the pertinent features of the disclosed subject matter. These features are merely illustrative.

### BRIEF DESCRIPTION OF THE DRAWINGS

In the drawings, each identical or nearly identical component that is illustrated in various figures is represented by a like reference character. For purposes of clarity, not every component may be labelled in every drawing. The drawings are not necessarily drawn to scale, with emphasis instead being placed on illustrating various aspects of the techniques and devices described herein.

FIG. 1 is a block diagram of an exemplary system that accesses data from an external memory according to some embodiments.

FIG. 2A illustrates an exemplary memory transfer scheme according to some embodiments.

FIG. 2B illustrates operations involved in the exemplary memory transfer scheme of FIG. 2A according to some embodiments.

FIG. 3A illustrates exemplary memory operations associated with copying data from an external memory to an internal memory and loading data from the internal memory to a processor according to some embodiments.

FIG. 3B illustrates exemplary memory operations associated with storing data from a processor to an internal memory and copying data from the internal memory to an external memory according to some embodiments.

FIG. 4 is a process flow of a method of controlling memory operations associated with copying data from an external memory to an internal memory and retrieving data from the internal memory by one or more processors according to some embodiments.

FIG. 5 is a process flow of a method of controlling memory operations associated with storing data from one or more processors in an internal memory and copying data from the internal memory to an external memory according to some embodiments.

### DETAILED DESCRIPTION

Reference will now be made to the drawings to describe the present disclosure in detail. It will be understood that the drawings and exemplified embodiments are not limited to the details thereof. Modifications may be made without departing from the spirit and scope of the disclosed subject matter.

As noted, APIs facilitate seamless communication and data transfer between applications. Latency or delay time between a request for data by one of the applications and fulfilment of that request can affect the efficacy of an API based on the user experience created by the latency. A contributing factor in latency is the time it takes for a processor implementing the API functionality to transfer data from long-latency memory to fast memory. Long-latency memory (also called external memory or secondary memory) may generally be regarded as memory that is not directly connected to the processor implementing the API functionality, and fast memory (also called internal memory or primary memory) may be memory that is connected to and directly accessibly by the processor implementing the API functionality. Long-latency or secondary memory is accessible via the fast or primary memory. Some examples of long-latency memory include cloud storage, solid state drives, and optical disks, and some examples of fast memory include read-only memory (ROM), random access memory (RAM), and cache memory.

When the processor implementing the API functionality needs to load and use data that is stored in long-latency memory or write data into long-latency memory, the latency associated with transfer of that data between the long-latency memory and fast memory can be noticeable to a user of the API. At the same time, storage capacity of long-latency memory is typically larger than storage capacity of fast memory. Thus, all the data in long-latency memory cannot may not be able to be moved to fast memory at once to make it all faster to access, for example. A prior approach to decreasing the latency in data access from long-latency memory involves moving a subset of data from the long-latency memory to fast memory to decrease the latency involved in accessing that subset of data. However, prior implementations of this approach may require tracking availability of storage in fast memory to determine when more data may be copied in from long-latency memory, as well as management of the memory addresses in fast memory. That is, as data is put into fast memory from long-latency memory, via program commands, and then released, a programmer of an API may need to include commands to calculate the memory addresses in the fast memory. This can be cumbersome.

Beneficially, any one or a combination of the approaches detailed herein facilitates automated copy of data from long-latency memory to fast memory whenever space is available in fast memory. The space may be referenced in units referred to as tiles or blocks, for example, and fast memory may include a one or two-dimensional array of tiles/blocks. In addition to the automated copy, the need for address determination and management may be eliminated through the use of multiple pointers. This approach can hide the latency associated with access of data from the long-latency memory by making the data available in fast memory before it is needed by the processor while potentially avoiding the need to manage addresses. While APIs are specifically discussed for explanatory purposes, any application that requires access to secondary memory stores may benefit from aspects of the automated copy and pointer-based access detailed herein.

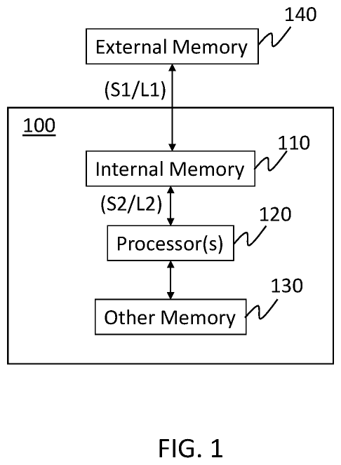

FIG. 1 is a block diagram of aspects of an exemplary system 100 having access to an external memory 140, according to some embodiments. The external memory 140 may be organized in a plurality of blocks or tiles, for example. The system 100 includes internal memory 110, which typically has a smaller storage capacity than the external memory 140. The internal memory 110 may also be organized in a plurality of blocks or tiles. The system 100 includes one or more processors 120 that can directly access the internal memory 110 but cannot directly access the external memory 140. An access speed S1 and latency L1 may be associated with transfer of data between the external memory 140 and internal memory 110. An access speed S2 and latency L2 may be associated with transfer of data between the one or more processors 120 and internal memory 110. The access speed S2 may be faster than S1. As such, the latency L2 may be smaller than L1, since access speed and latency are inversely proportional.

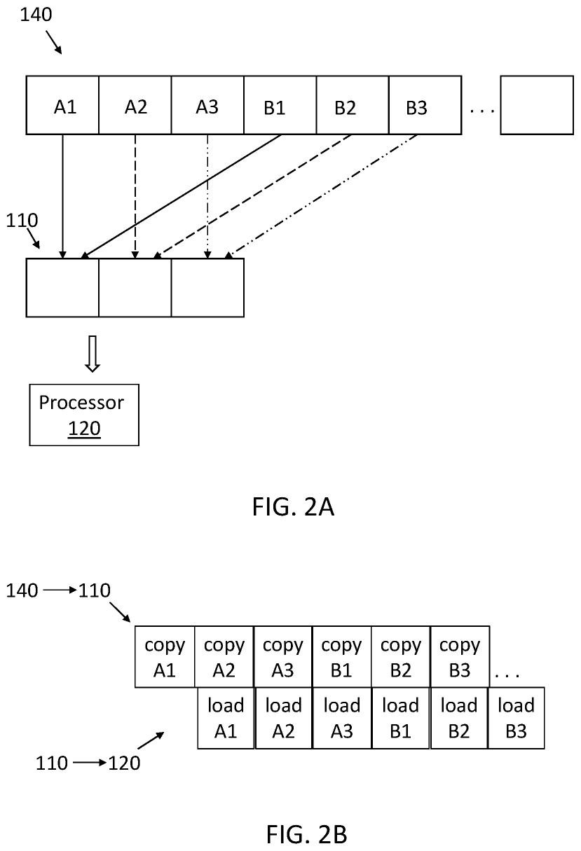

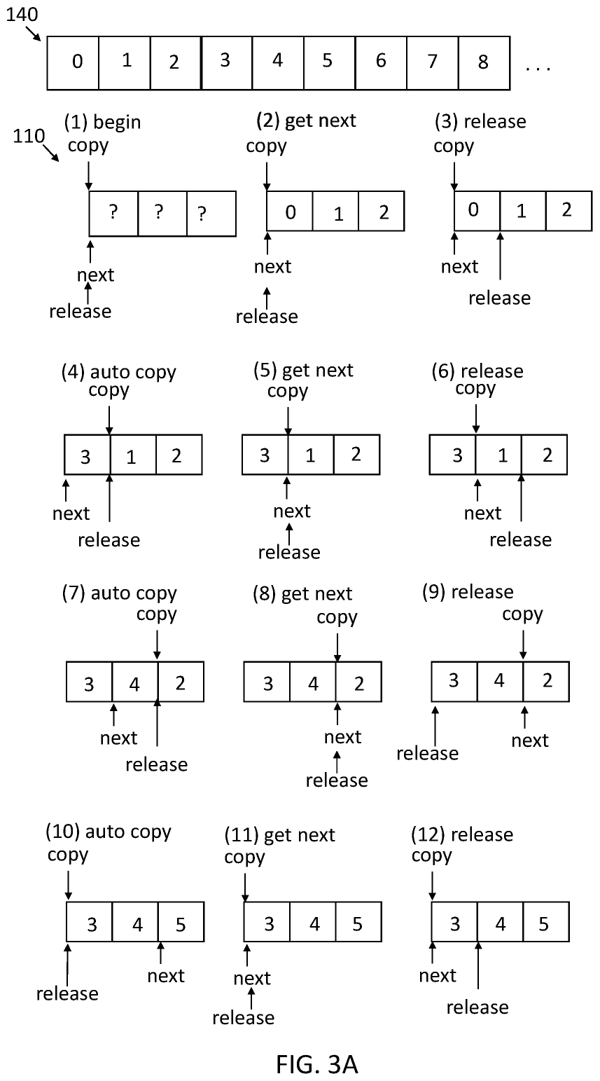

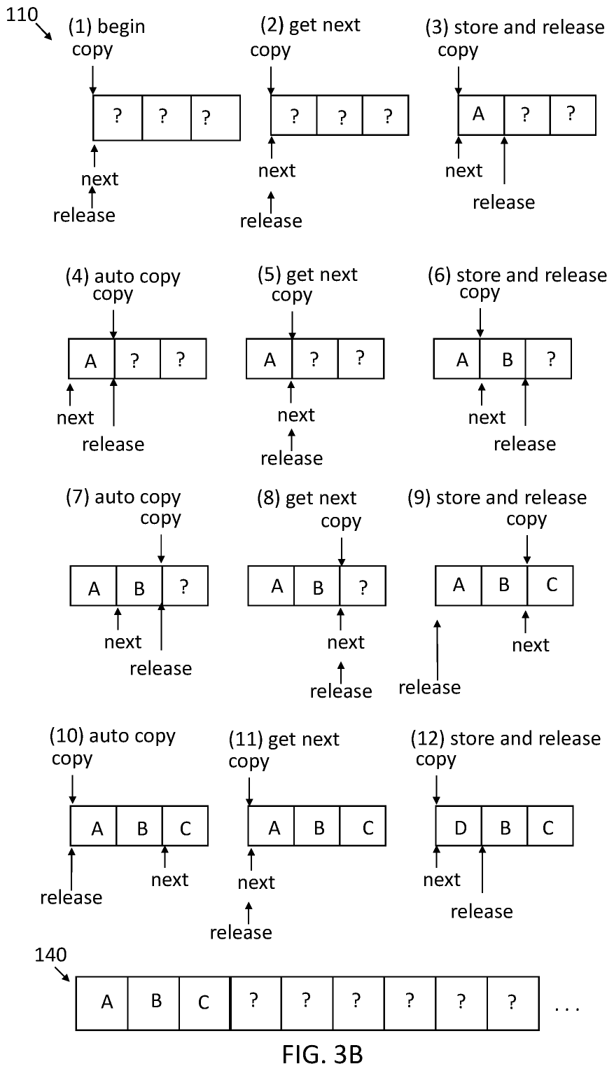

The system 100 may also include other memory 130. The other memory 130 may, for example, store instructions that cause the processor 120 to implement operations such as those of an API. The system 100 may also include other components that facilitate the functionality of the system 100. When one or more blocks of memory are unused in the internal memory 110, data is automatically copied from external memory 140 into the available blocks of internal memory 110. Instructions (e.g., stored in other memory 130) that are processed by one or more processors 120 may access data in internal memory 110 using a pointer that stores the address of the next readable block of data in internal memory 110 rather than by determining an address with which to access the data. Additional pointers may be used to determine whether an automatic copy may be implemented from external memory 140 to internal memory 110 and whether data in internal memory 110 has been loaded for use into one or more processors 120 such that the data may be released from internal memory 110 to accommodate an additional copy from external memory 140. The use of the pointers is discussed with reference to FIGS. 2A through 3B.

FIG. 2A illustrates an exemplary memory transfer scheme according to some embodiments. Exemplary blocks of external memory 140 are shown to include data indicated as A1-A3 and B1-B3. Exemplary internal memory 110 is shown to include three blocks. The exemplary illustrations are not intended to limit the arrangement or number of memory blocks of the external memory 140 or internal memory 110. For example, the memory blocks may be arranged in a two-dimensional array and may include any number of memory blocks.

As the arrows indicate, the three blocks of internal memory 110 are first respectively populated with data A1, A2, A3 via an automated copy from external memory 140 (i.e., data A1 is copied to the first block of internal memory 110, data A2 is copied to the second block, and data A3 is copied to the third block). As each block of the data is read out of internal memory 110 (i.e., loaded into the processor 120), an automated copy is performed to fill the block. For example, after data A1 is loaded into the processor 120 from the internal memory 110, the first block of internal memory 110 is populated with data B1 via an automated copy from external memory 140, as indicated by the arrow. After data A2 is loaded into the processor 120, the second block of internal memory 110 is populated with data B2 via an automated copy from external memory, and after data A3 is loaded into the processor 120, the third block of internal memory 110 is populated with data B3 via an automated copy from external memory.

FIG. 2B illustrates operations involved in the exemplary memory transfer scheme of FIG. 2A according to some embodiments. FIG. 2B illustrates the sequential automated copy operations from external memory 140 to internal memory 110 and the load operations from internal memory 110 to the processor 120 that may be performed at least partially in parallel with the automated copy operations. As detailed with reference to FIGS. 3A and 3B, different pointers may be used to determine the next block of internal memory 110 data should be automatically copied into from external memory 140, the next block of internal memory 110 data may be read from or written to by the processor 120, and the next block of internal memory 110 that may be read from or copied into by the external memory 140.

FIG. 3A illustrates examples of memory operations associated with copying data from external memory 140 to internal memory 110 and loading data from the internal memory 110 to a processor 120 according to some embodiments. In the exemplary illustration, nine data blocks of the external memory 140 are indicated and the internal memory 110 is shown to include three memory blocks. As previously noted, this exemplary illustration does not limit the numbers and arrangements of memory blocks in external memory 140 and internal memory 110.

A sequence of snapshots of the internal memory 110 is numbered from “(1)” to “(12)”. In each snapshot of the sequence, the locations of three pointers, “copy,” “next,” and “release,” are indicated. The copy pointer stores the address of the next block of internal memory 110 that data can be copied into from external memory 140 and is automatically incremented each time an automated copy from external memory 140 to internal memory 110 is completed. Thus, at sequence (1), the copy pointer indicates the first block of internal memory 110. Between sequence (1) and sequence (2), an automated copy was performed to populate all three blocks of internal memory 110, as shown. Thus, the copy pointer is back to the beginning in sequence (2) to indicate the first block of internal memory 110 as the next block to automatically copy into again.

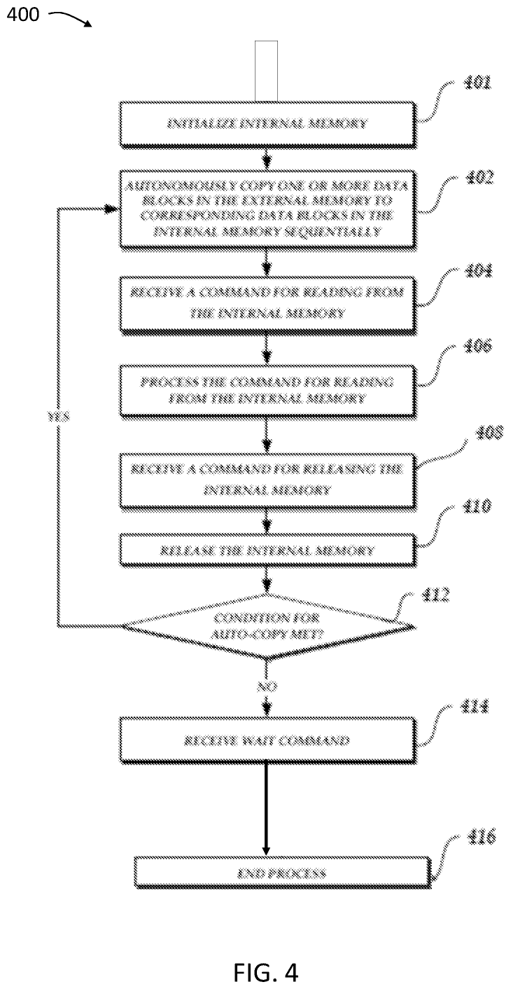

The next pointer may be used in program instructions (e.g., stored in other memory 130) to load data into internal memory 110 by one or more processors 120 or out of internal memory 110 to one or more processors 120 (e.g., into or out of blocks between the next pointer and the copy pointer). The release pointer may also be used in program instructions and specifies the block(s) of internal memory 110 available for automated copy (e.g., blocks between the copy pointer and the release pointer). Unlike the copy pointer, which is updated automatically following an automated copy, the next and release pointers are updated using program instructions. As exemplary illustrations in FIG. 3A indicate, an automated copy from external memory 140 to internal memory 110 is triggered by user control of the next and release pointers via program instructions. The headings of each of the sequences indicates an exemplary instruction that may be stored (e.g., in other memory 130) and processed by one or more processors 120. For example “get next” indicates an instruction to obtain the next block for reading or writing and “release” indicates an instruction to allow data to be overwritten. However, “auto copy” is not an instruction that is processed but, rather, an automated operation. As discussed with reference to FIG. 4, there may be checks associated with this instruction.

As FIG. 3A indicates, in the snapshots associated with sequences (2) to (3), (5) to (6), (8) to (9), and (11) to (12), the release pointer is incremented when data is loaded from a block of the internal memory 110 to the processor 120. That is, the next pointer, indicating the next block to load data from, and the release pointer initially point to the same block (e.g., as in sequence (2)), then the release pointer is incremented based on the load from the previously indicated block (e.g., as in sequence (3)). As the snapshots associated with sequences (3) to (4), (6) to (7), and (9) to (10) indicate, an automated copy is performed from external memory 140 to a released block in internal memory 110 and the copy pointer is automatically incremented following the copy.

As sequences (9) to (11) indicate, the pointers return to the first block after the third block in the exemplary internal memory 110 with three blocks. That is, the release pointer returns to the first block in sequence (9), the copy pointer returns to the first block in sequence (10), and the next pointer returns to the first block in sequence (11). Because the pointers cycle through the blocks in this manner, the internal memory 110 may be illustrated and regarded as a circular ring buffer according to some embodiments. As discussed with reference to FIG. 4, program code may be written to perform checks to ensure that only valid blocks or relevant error messages are obtained based on the positions of the pointers.

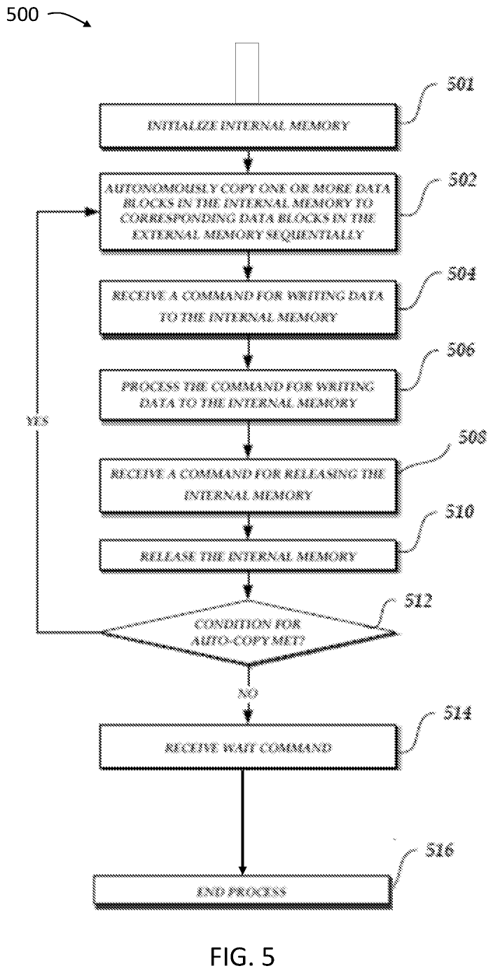

FIG. 3B illustrates examples of memory operations associated with storing data from the processor 120 to the internal memory 110 and copying data from the internal memory 110 to external memory 140 according to some embodiments. The exemplary illustration shows the nine data blocks of the external memory 140 and the internal memory 110 with three memory blocks as in FIG. 3A. Similarly to FIG. 3A, a sequence of snapshots of the internal memory 110 is numbered from “(1)” to “(12)”. In each snapshot of the sequence, the locations of the copy, next, and release are indicated. The headings are the same as those in FIG. 3A with the exception of “store and release” to indicate that data is written from internal memory 110 into external memory 140 before the block is released. Additional details are discussed with reference to FIG. 5.

As FIG. 3B indicates, in the snapshots associated with sequences (2) to (3), (5) to (6), (8) to (9), and (11) to (12), the release pointer is incremented when data is written into a block of the internal memory 110 from the processor 120. That is, the next pointer, indicating the next block to write data into, and the release pointer initially point to the same block (e.g., as in sequence (2)), then the release pointer is incremented based on data being written into the previously indicated block (e.g., as in sequence (3)). As the snapshots associated with sequences (3) to (4), (6) to (7), and (9) to (10) indicate, an automated copy is performed into external memory 140 from internal memory 110 and the copy pointer is automatically incremented following the copy. As noted with reference to FIG. 3A, because the pointers cycle through the blocks, as illustrated in sequences (9), (10), and (11), for example, the internal memory 110 may be illustrated and regarded as a circular ring buffer according to some embodiments.

FIG. 4 is a process flow of a method 400 of controlling memory operations associated with copying data from external memory 140 to internal memory 110 and retrieving data from the internal memory 110 by one or more processors 120 according to some embodiments. The processes may be performed by a system 100. Aspects of the operations are illustrated in FIG. 3A. At 401, initializing internal memory 110 may include setting the copy, release, and next buffers to store the same address, that of the first block of the internal memory 110 (e.g., as shown for sequence (1) in FIG. 3A). At 402, autonomously copying one or more blocks of data from external memory 140 to internal memory 110 sequentially is illustrated in sequence (2) of FIG. 3A, for example.

At 404, receiving a command for reading from the internal memory 110 refers to one or more processors 120 receiving instructions (e.g., stored in other memory 130) associated with reading data from internal memory 110. At 406, processing the command for reading from internal memory 110 may involve determining that a valid block of data is indicated by the next pointer, for example, and may involve a set of commands. For example a command to obtain the next pointer may first be issued to determine whether a valid block of data is available for access or if an error code is returned. One of more valid blocks of data for reading from internal memory 110 are blocks between the next pointer and copy pointer. Thus, if the next pointer and the copy pointer are in the same place, there are no valid blocks to read from. If the check at 406 passes, this may lead to one or more processors 120 then loading data from the internal memory 110. At 408, receiving a command for releasing the internal memory refers to one or more processors 120 implementing instructions to release a block or more of the internal memory 110, at 410, followed by incrementing the release pointer.

At 412, a check may be performed to determine if conditions for automated copy from external memory 140 to internal memory 110 are met. For example, a check may be performed of whether the address indicated by the copy pointer is the same as the address indicated by the release pointer. If the check at 412 indicates that the condition for automated copy is met (e.g., there is at least one block between the copy pointer and the release pointer), then another iteration beginning at 402 may be implemented. If, instead, the result of the check at 412 is that the condition for automated copy is not met, then the process of copying from external memory is ended. Because this is an asynchronous end, a (synchronous) command to wait may be received, at 414. That is, the instructions implemented by one or more processors 120 may include a wait instruction to wait synchronously until the corresponding asynchronous end is complete if the condition checked at 412 is not met. Following the wait, the process may be ended at 416. The end (at 416) may indicate a release of the internal memory 110 which may subsequently be re-initialized (at 401). The process at 414 may also be reached if the check that is part of the processing of the read command (at 406) indicates that a valid block is not available in internal memory 110.

FIG. 5 is a process flow of a method 500 of controlling memory operations associated with storing data from one or more processors 120 in internal memory 110 and copying data from internal memory 110 to external memory 140 according to some embodiments. Aspects of the operations are illustrated in FIG. 3B. Like the processes of the method 400, the processes of the method 500 may be performed by a system 100. At 501, initializing internal memory 110 may including setting the copy, release, and next buffers to store the same address, that of the first block of the internal memory 110 (e.g., as shown for sequence (1) in FIG. 3B). At 502, autonomously copying one or more blocks of data from internal memory 110 to external memory 140 sequentially is illustrated, for example, by the copy of “A” out of the first block of internal memory 110 at sequence (4) of FIG. 3B.

At 504, receiving a command for writing data to internal memory 110 from one or more processors 120 refers to the one or more processors 120 receiving instructions to write data into internal memory 110. At 506, processing the command for writing data to internal memory 110 may include verifying that a valid block of internal memory 110 is available. This verification may involve comparing the address of the next pointer, which indicates the address of a block of internal memory 110, to the address of the copy pointer to ensure that there is at least one block between the next pointer and the copy pointer. As previously noted, the circular access (e.g., first block is reached after the last block according to the arrangement in FIG. 3B) must be considered in performing this verification. That is, an address (e.g, first block address) that is past another address (e.g., last block address) may have a lower address value and an address (e.g., last block address) that precedes another address (e.g., first block address) may have a higher address value due to the circular scheme discussed with reference to FIGS. 3A and 3B. Thus, the copy pointer may have a lower address value than the next pointer when there is at least one block between the next pointer and the copy pointer. Based on the verification, one or more processors 120 may write data into one or more blocks of internal memory 110. At 508, receiving a command for releasing the internal memory refers to one or more processors 120 implementing instructions to release a block or more of the internal memory 110, at 510, followed by incrementing the release pointer.

At 512, a check may be performed to determine if conditions for automated copy from internal memory 110 to external memory 140 are met. This check may be similar to the one discussed with reference to 412 of the method 400 of FIG. 4, for example. The check is to determine whether there are one or more blocks between the copy pointer and the release pointer. Based on the result of the check at 512 indicating that the condition for automated copy is met, then another iteration beginning at 502 may be implemented. If, instead, the result of the check at 512 is that the condition for automated copy is not met, then a command to wait may be received, at 514, to address the asynchronous end of the process. Following the completion of the synchronous wait command, the process may be ended at 516.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions implementing the techniques described herein (when implemented as one or more functional facilities or in any other manner) may, in some embodiments, be encoded on one or more computer-readable media, machine-readable media, etc., to provide functionality to the media. Computer-readable media include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium may be implemented in any suitable manner. As used herein, the terms “computer-readable media” (also called “computer-readable storage media”) and “machine-readable media” (also called “machine-readable storage media”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A method of managing access to a first memory via a second memory, access to the first memory being at a first speed and the first memory comprising a first plurality of data blocks, access to the second memory being at a second speed, different from the first speed, and the second memory comprising a second plurality of data blocks, the method comprising:
autonomously copying data from one or more of the data blocks in the first plurality of data blocks in the first memory to corresponding one or more of the data blocks in the second plurality of data blocks in the second memory sequentially;
receiving a command for reading from the second memory;
responsive to receiving the command for reading from the second memory, obtaining a pointer indicating an address of a data block in the second memory that contains data copied from the first memory and that is first available for access; and
obtaining the data from the data block based on the pointer.

2. The method of claim 1, wherein the second speed is faster than the first speed.

3. The method of claim 1, wherein the second memory is internal memory that is directly connected to one or more processors and the first memory is external memory not directly connected to the one or more processors.

4. The method of claim 1, wherein autonomously copying comprises performing one or more iterations of operations comprising:
using a copy pointer indicative of an address of a next data block in the second memory that is available to receive data from the first memory;
copying data from one of the first plurality of data blocks in the first memory to the next data block in the second memory; and
incrementing a value of the copy pointer.

5. The method of claim 4, wherein autonomously copying further comprises determining whether to stop the one or more iterations, by:
determining whether the copy pointer indicating the address of the next data block in the second memory that is available to receive data from the first memory is at an address indicated by a release pointer:
responsive to determining that the copy pointer indicates the address that is at the address indicated by the release pointer, stopping the one or more iterations; and
responsive to determining that the copy pointer indicates the address that is not at the address indicated by the release pointer, continuing the one or more iterations.

6. The method of claim 5, further comprising:
responsive to receiving the command for releasing the second memory, incrementing the release pointer.

7. The method of claim 6, further comprising initializing the second memory by setting the pointer, the copy pointer, and the release pointer to an initial location in the second memory.

8. The method of claim 7, wherein
initializing the second memory further comprises triggering the autonomously copying, and
the second memory includes a first data block and a last data block, and incrementing any of the pointer, the copy pointer, and the release pointer past the last data block of the second memory advances to the first data block of the second memory.

9. The method of claim 6, further comprising:
determining whether a condition for auto-copy is met based on the copy pointer and the release pointer; and
responsive to determining that a condition for auto-copy is met, triggering the autonomously coping.

10. The method of claim 1, further comprising:
responsive to receiving a wait command, determining whether an event is completed;
responsive to determining that the event is completed, terminating the autonomously copying.

11. The method of claim 1, further comprising:
autonomously copying one or more of the plurality of data blocks in the second memory to corresponding data blocks in the first memory;
receiving a command for writing data to the second memory;
responsive to receiving the command for writing to the second memory, obtaining the pointer indicating an address of a data block in the second memory that is available to store new data; and
writing the data as the new data in the data block based on the pointer.

12. A system comprising:
an internal memory; and
one or more processors configured to access an external memory via the internal memory, access to the first memory being at a first speed and the first memory comprising a first plurality of data blocks, access to the second memory being at a second speed, different from the first speed, and the second memory comprising a second plurality of data blocks, the one or more processors configured to:
autonomously copy one or more of the data blocks in the plurality of data blocks in the external memory to corresponding data blocks in the internal memory;
receive a command for reading from the internal memory;
responsive to receiving the command for reading from the internal memory, obtain a pointer indicating an address of a data block in the internal memory that contains data copied from the external memory and is available for access and obtaining the data from the data block based on the pointer.

13. The system of claim 12, wherein the second speed is faster than the first speed.

14. The system of claim 12, wherein the one or more processors are configured to perform one or more iterations of operations comprising:
using a copy pointer indicative of an address of a next data block in the internal memory that is available to receive data from the first memory;
copying data in a corresponding data block of the plurality of data blocks in the external memory to the next data block in the internal memory; and
incrementing the copy pointer.

15. The system of claim 14, wherein the one or more processors are configured to determine whether to stop the one or more iterations, by:
determining whether the copy pointer indicating the address of the next data block in the internal memory that is available to receive data from the first memory meet or pass a release pointer;
responsive to determining that the copy pointer meet or pass the release pointer:
stopping the one or more iterations; otherwise
continuing the one or more iterations.

16. The system of claim 14, wherein the one or more processors is further configured to:
receive a command for releasing memory;
responsive to receiving the command for releasing memory, incrementing the release pointer.

17. The system of claim 16, wherein the one or more processors is further configured to initialize the internal memory by setting the pointer, the copy pointer, and the release pointer to an initial location in the internal memory, and to trigger the autonomous copying.

18. The system of claim 17, wherein the plurality of data blocks in the internal memory are arranged in a data structure such that a first data block of the plurality of data blocks appends to a last data block of the plurality of data blocks in the internal memory, and the one or more processors incrementing any of the pointer, the copy pointer, and the release pointer past the last data block of the internal memory advances the any of the pointer, the copy pointer, and the release pointer to the first data block of the internal memory.

19. The system of claim 16, wherein the one or more processors is further configured, responsive to determining that the copy pointer meets an auto-copy condition, to trigger the autonomous coping.

20. The system of claim 12, wherein the one or more processors is further configured to:
autonomously copy one or more of the plurality of data blocks in the internal memory to corresponding data blocks in the external memory;
receive a command for writing data to the internal memory;
responsive to receiving the command for writing to the internal memory, determine the pointer indicating the address of a data block in the internal memory that is available to store new data; and
write the data as the new data in the data block based on the pointer.

21. The system of claim 12, wherein the one or more processors is configured to maintain the pointer indicating an address of a data block in the internal memory that contains data copied from the external memory and is available for access, a copy pointer indicating an address of a next data block in the internal memory that is available to receive data from the external memory, and a release pointer indicating an address of a last data block in the internal memory that is available to receive data from the external memory.

22. The system of claim 21, wherein the plurality of data blocks in the internal memory are logically arranged in an order, wherein a last data block in the internal memory references a first data block in the internal memory such that incrementing the pointer indicating the last data block in the buffer results in the pointer indicating the first data block in the buffer.
